(19) United States
(12) Patent Application Publication
(10) Pub. No.: US 2019/0191740 A1
(43) Pub. Date: Jun. 27, 2019

(54) Methods to Promote Growth and Improve Feed Conversion in Animals

(71) Applicant: Nutrivert LLC, Atlanta, GA (US)

(72) Inventors: Horace Disston Nalle, JR., Atlanta, GA (US); Bernhard Kaltenboeck, Auburn, AL (US)

(73) Assignee: Nutrivert LLC, Atlanta, GA (US)

(21) Appl. No.: 16/311,201

(22) PCT Filed: Jun. 22, 2017
(86) PCT No.: PCT/US17/38790

§ 371 Date: Dec. 19, 2018

Related U.S. Application Data
(60) Provisional application No. 62/353,994, filed on Jun. 23, 2016.

(51) Int. Cl. A23K 20/147; A23K 10/10

(52) U.S. Cl. CPC A23K 20/147; A23K 20/158; A23K 10/10

(57) ABSTRACT

The present application provides methods to promote growth and improve feed conversion in animals by administering to the animal an effective amount of a composition comprising PGN, MDP or an MDP analog, or a combination thereof.

### PRIOR RELATED APPLICATION

This application claims the benefit of U.S. Provisional Application Ser. No. 62/353,994, filed Jun. 23, 2016, titled “Methods of improving gut health in vertebrates” the entire contents of which are hereby incorporated by reference.

### FIELD OF THE INVENTION

The field of the present invention relates to methods to promote growth and improve feed conversion in animals by administering an effective amount of a composition comprising peptidoglycan (PGN), muramyl dipeptide (MDP) or an MDP analog to animals.

### BACKGROUND

Antimicrobial growth promoters (AGPs) increase weight gain and improve feed conversion in vertebrates. Although AGPs are antimicrobial agents, they have historically been approved for use in doses that fall below the minimum inhibitory concentration (MIC), which is the lowest concentration of an antibiotic that will inhibit the visible growth of a microorganism after overnight incubation. Despite being administered at sub-MIC doses, AGPs promote growth in livestock. Two ways of measuring enhanced growth are measuring growth in mass per unit of time and measuring growth in mass per unit of nutrition; the latter is sometimes referred to as feed conversion. References herein to enhancement or improvement of growth refer to both parameters unless otherwise specified. Promotion of growth by either measure is economically useful in the production of animal protein for consumption by humans and other animals.

There are medical, regulatory and commercial pressures to reduce the administration of antibiotics to animals. One of the rationales for such a reduction is the belief, widespread among experts, that use of antibiotics in animals, and especially use of antibiotics in animals at subtherapeutic doses, selects for resistant strains of bacteria, exposing humans to bacterial infections that are refractory to antibiotic treatment. The use of antibiotics to promote growth and feed efficiency is increasingly prohibited or restricted, and the approvals for use at subtherapeutic doses, described above, have been rescinded in the United States. However, animal protein raised without growth promoters is more expensive to produce than animal protein in animals raised with growth promoters. Added expense is due to additional feed required, prolonged housing time and additional veterinary and maintenance costs. Accordingly, what is needed are methods that promote growth, improve feed efficiency, and reduce the cost of production of animal protein, without the disadvantages associated with AGPs.

### BRIEF SUMMARY

The present invention solves this problem by providing methods that surprisingly promote growth, improve feed efficiency, and reduce the cost of production of animal protein, without the disadvantages associated with AGPs by administering compositions comprising PGN, MDP or an MDP analog to animals.

The methods of the present invention increase growth of animals and improve feed efficiency without exposing the animals to antibiotics which can enhance resistant strains of bacteria and expose humans to bacterial infections in animal protein that are refractory to antibiotic treatment.

In one embodiment there is provided a method that promotes growth, improves feed efficiency, and reduces the cost of production of animal protein by administering a composition comprising MDP to animals.

In another embodiment there is provided a method that promotes growth, improves feed efficiency, and reduces the cost of production of animal protein by administering a composition comprising an MDP analog to animals.

In yet another embodiment there is provided a method that promotes growth, improves feed efficiency, and reduces the cost of production of animal protein by administering a composition comprising PGN to animals.

Many different animals raised for protein consumption may be treated with the methods described herein, including vertebrates and invertebrates. The present methods surprisingly enhance animal growth and more efficiently produce animal protein for consumption, thereby decreasing the cost of animal protein.

Other objects and advantages of the invention will be apparent from the following summary and detailed description of the embodiments of the invention taken with the accompanying drawing figures.

### BRIEF DESCRIPTION OF THE FIGURES

FIG. 1. Results of the broiler chicken feed conversion experiment in Example 1.

FIG. 1A: Body weight gain per chicken over the course of the experiment from start on day 0 through termination on day 32. Data shown are means±95% confidence interval (95% CI).

FIG. 1B: Total feed consumed per chicken from day 0 through day 32, means±95% CI. Broilers fed the muramyl dipeptide analog mifamurtide consumed less feed than did negative controls. FIG. 1C: True feed conversion as determined by dividing total consumed feed by total weight gains of all chickens of the group. Error bars indicate 25-75 percentiles of calculated feed conversions of individual birds. All significant group differences are indicated by dashed brackets and the corresponding p value.

FIG. 2. Results of the broiler chicken experiment in Example 2. (A) Body weight per chicken at termination on day 32. Data shown are means±95% confidence interval (95% CI). (B) Body weight gains in weight units per chicken from day 15 through day 32, means±95% CI. (C) Body weight gains in percent units per chicken from day 15 through day 32, means±95% CI. Husbandry conditions were optimal in this experiment, and morbidity and mortality rates were marginal and did not differ between the groups. All significant group differences are indicated by dashed brackets and the corresponding p value.

FIG. 3. Results of the pig feed conversion experiment in Example 3. (A) Body weight gain per pig over the course of the experiment from start on day 0 through day 26. Data shown are means±95% CI. (B) Total feed consumed per pig from day 0 through day 26, means±95% CI. (C) True feed conversion as determined by dividing total consumed feed by total weight gains of all pigs of the treatment. Error bars indicate 25-75 percentiles of calculated feed conversions of individual pigs. No morbidity or mortality was observed. All significant group differences are indicated by dashed brackets and the corresponding p values.

FIG. 4. Representative analogs of MDP are shown in FIG. 4. Murabutide, romurtide, MDP-C and mifamurtide are representative lipophilic MDP derivatives with an intact MDP core structure. See Gobec et al. European Journal of Medicinal Chemistry 116 (2016) 1-12. Compounds 3, 4, 5, and 6 are MDP analogs generated as described in Cai et al. J. Med. Chem. 59 (2016) 6878-6890. DFK1012 is an MDP analog as described in Lee et al. J. Biol. Chem. 286 (2011) 5727-5735. Further MDP analogs include, from Gobec, cited above: Compound 14: Diethyl (5-phenyl-1H-indole-2-carbonyl)glycyl-L-alanyl-D-glutamate, Compound 16: Diethyl (6-phenyl-1H-indole-2-carbonyl)glycyl-L-alanyl-D-glutamate; and Compound 20, a dibenzyl analog described therein. Further MDP analogs are L18-MDP(Ala), which is 6-O-Stearoyl-N-acetylmuramyl-L-alanyl-D-isoglutamine; 6-O—[CH₃(CH₂)₁₆CO]-MurNAc-L-Ala-D-isoGln, and MDP-Lys(L18), which is N^{α}—(N-acetylmuramyl-L-alanyl-D-isoglutaminyl)-N^{ε}-stearoyllysine; MurNAc-L-Ala-D-Glu[Lys(CO—(CH₂)₁₆—(CH₃)—OH]—NH₂ as described in Matsumoto et al. Infection and Immunity 39 (1983) 1029-1040. The synthesis of a series of further MDP analogs including LK415 is described in U.S. Pat. No. 5,514,654. LK-423 {N-[2-(2-phthalimidoethoxy)acetyl]-L-alanyl-D-glutamic acid} is another MDP analog synthesized similarly and described in Smrdel at al. Drug Development and Industrial Pharmacy 35 (2009) 1293-1304.

### DETAILED DESCRIPTION

The present invention solves the problems described above that arise from using AGPs by providing methods that promote growth, improve feed efficiency, and reduce the cost of production of animal protein, without the disadvantages associated with AGPs by administering compositions comprising PGN, MDP or an MDP analog, or a combination thereof, to animals. The present invention includes the use of PGN, MDP or an MDP analog in the preparation of a medicament for increasing growth or feed conversion in an animal. The present invention includes PGN, MDP or an MDP analog for use in enhancing growth or feed conversion in an animal.

### Animals

The method of the present invention may be used with a large variety of animals including vertebrates and invertebrates. In one embodiment, the animals to be treated preferably have an alimentary canal. It is to be understood that the term animal includes humans.

Vertebrates which may be treated with the method of the present invention include without limitation any vertebrate raised for food consumption including, but not limited to, fish including salmon, bass, cod, tilapia, catfish and trout, chickens, pigs, cattle, bison, gayal, zebu, turkeys, sheep, goats, donkeys, ducks, pigeons, quail, geese, camels, llamas, alpacas, dogs and horses.

Invertebrates which may be treated with the method of the present invention include without limitation any invertebrate raised for food consumption including, but not limited to, shrimp, prawn, snail, crayfish, lobsters, crabs, squid, octopus, oysters, clams and mussels.

In one embodiment, compositions comprising PGN, MDP or an MDP analog are preferably administered orally. Oral administration may be in drinking water, animal feed or through other means.

### PGN, MDP and MDP Analogs

In one embodiment, compositions comprising PGN may be employed in the practice of the present invention. In one embodiment PGN includes but is not limited to PGN derived from different species such as Streptomyces spp. In another embodiment PGN includes but is not limited to Lys-type PGN or DAP-type PGN.

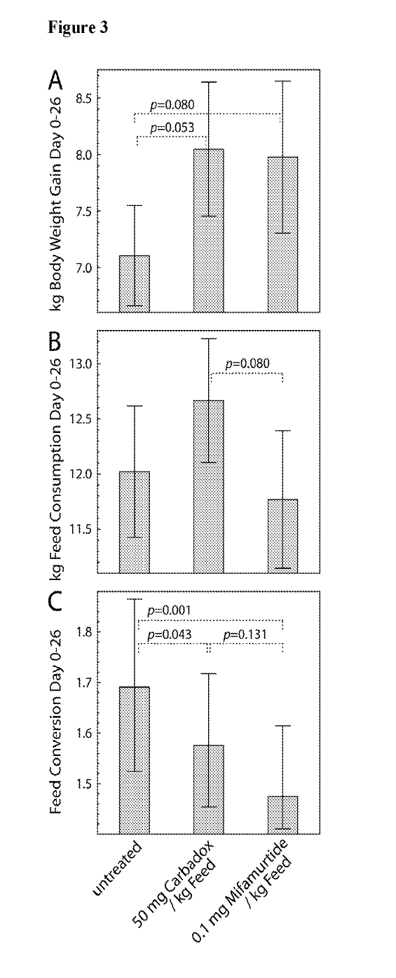

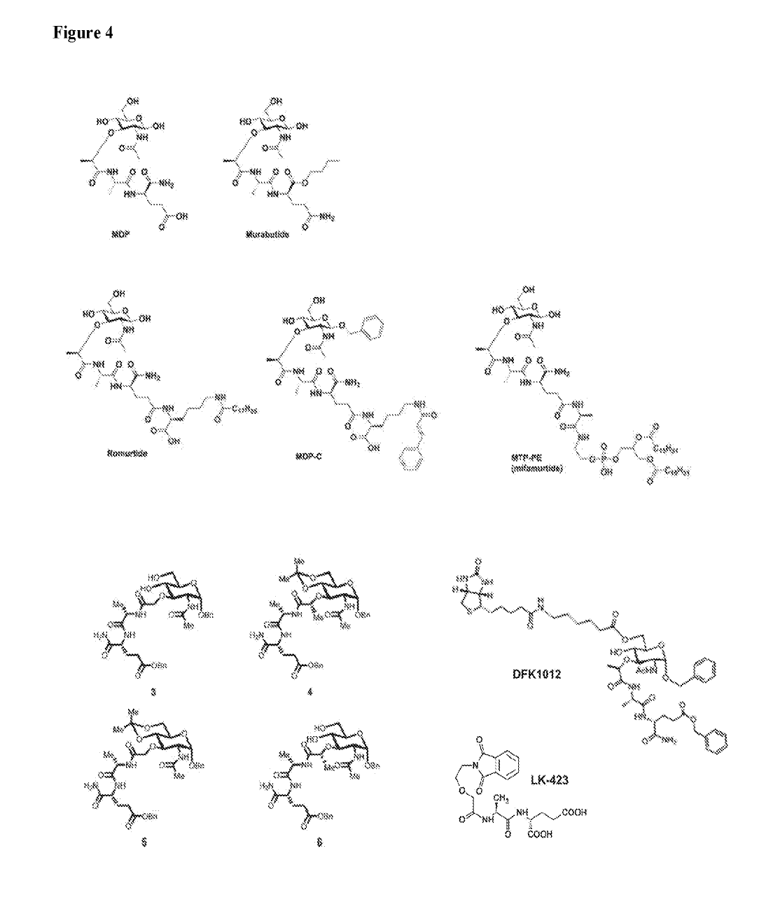

In yet another embodiment, compositions comprising MDP or an MDP analog may be employed in the practice of the present invention. MDP analogs include without limitation romurtide, mifamurtide, 6-O-stearoyl-N-Acetyl-muramyl-L-alanyl-D-isoglutamine (L18-MDP) and murabutide. Examples of other MDP analogs are shown in FIG. 3. In still another embodiment, PGN, MDP, an MDP analog, or a combination thereof, may be administered to the animal.

### Dose Ranges

The ranges of daily uptakes of the described compounds vary by species and by the body weight of the animal. As a general rule, dose rates in milligrams per kilogram decline as body weight rises based on allometric scaling of total dosage by body weight. West et al. PNAS 99 (2002) suppl 1, 2473-2478. In allometric scaling the relative dosages of a drug for two individuals are approximately equivalent to the ratio of the individuals' body weights to the power of ¾.

The ranges of daily uptakes of mifamurtide by broiler chickens as determined in Examples 1 and 2 are based on typical body weights and daily feed intake. For a dosage of 0.1 mg mifamurtide/kg feed, the average total daily oral mifamurtide intake will range from 1.2 μg mifamurtide in freshly hatched chickens with 45 g body weight and 12 g daily feed intake to 22 μg mifamurtide in 6-7 week-old chickens with 3 kg body weight and 220 g daily feed intake. For the higher dosage of 1.9 mg mifamurtide/kg feed, the corresponding range is 22.8-418 μg mifamurtide. In pigs in Example 3, the dose range for 0.1 mg mifamurtide/kg feed is 35 μg total mifamurtide intake in 4 week-old freshly weaned pigs of 7 kg body weight with 350 g daily feed intake and 190 μg mifamurtide in 16 week-old pigs of 65 kg body weight and 1.9 kg daily feed intake.

Based on these dose calculations, and allowance for effective doses exceeding this range of observed effectiveness, the described compounds PGN, MDP, mifamurtide, romurtide, and any other MDP analog may be given at total daily doses ranging from 0.0005 μg to 2500 mg, and at daily dose rates ranging from 0.01 μg/kg to 150 mg/kg body weight.

In other embodiments, the daily dose range may be 0.001 μg to 1500 mg, 0.005 μg to 1000 mg, 0.01 μg to 500 mg, 0.05 μg to 250 mg, 0.01 μg to 100 mg, 0.1 μg to 500 mg, or 1.0 mg to 250 mg. It is to be understood that any number falling within these ranges may be the daily dose.

In different embodiments, the daily dose range may be from 0.05 μg/kg to 100 mg/kg body weight, 0.1 μg/kg to 75 mg/kg, 0.5 μg/kg to 50 mg/kg, or 1.0 mg/kg to 50 mg/kg. It is to be understood that any number falling within these ranges may be the daily dose range.

### Frequency of Administration

In different embodiments, PGN, MDP or an MDP analog is mixed into the animal feed. In another embodiment, PGN, MDP or an MDP analog are mixed into the animal's drinking water.

In one embodiment, PGN, MDP or an MDP analog is administered at least once per day. In other embodiments, PGN, MDP or an MDP analog is administered every two days, every three days, every four days or less frequently. Administration may begin on the first day of life or within the next seven days.

Delivering the preparation to the gut via the oral route will concentrate its effect there. For growth promotion, administration of the oral preparation will deliver the PGN, MDP or MDP analog to the intestinal lumen. Other routes of administration include without limitation rectal administration, for example in a suppository.

Compositions suitable for oral administration include without limitation powders or granules, suspensions or solutions in water or non-aqueous media, capsules, sachets, or tablets as known to one of ordinary skill in the art. Thickeners, flavorings, diluents, emulsifiers, dispersing aids or binders can be desirable. Preparations that deliver the agent to the intestines without denaturing in the stomach are preferred. Preparations that deliver the active ingredient in nanobeads, microbeads, or beads of a diameter one or two orders of magnitude greater than microbeads, can enhance delivery of the active ingredient by reducing degradation and metabolism in the stomach. Such administration can also enhance uptake in targeted cells in the intestinal tract including but not limited to gastrointestinal epithelial cells and subepithelial immune cells such as M cells in Peyer's patches. These advantages can reduce the dose required for administration. Various methods for doing this are well known to one of ordinary skill in the art. For livestock, preparations may be made that assure stability at temperatures at which pelletization occurs.

For growth promotion, a composition comprising PGN, MDP or an MDP analog is delivered in such a fashion as to reach cells in or near the gastrointestinal tract in sufficient dosages to be effective there.

For improvement in growth or feed conversion, a composition comprising PGN, MDP or an MDP analog is prepared for administration to an animal. In a preferred embodiment, compositions for oral administration are formulated to prevent chemical alteration in the stomach and thus increase amounts of the composition that are available in the intestines. Such formulations are known to one of ordinary skill in the art.

In one embodiment to enhance growth promotion, preferentially, for livestock, the PGN, MDP or an MDP analog is delivered in the feed. In some embodiments, it is delivered in a preparation that is heat and moisture stable and able to be pelletized with other feed ingredients. Chronic or regular oral administration of the PGN, MDP or an MDP analog will maintain effective levels in the gastrointestinal tract.

The compositions using MDP or MDP analogs provided herein can be administered in a number of ways depending on whether local or systemic treatment is desired, and on the area to be treated. The disclosed substances can be administered, for example, orally, intravenously, by inhalation, intranasally, intrarectally, intraperitoneally, intramuscularly, subcutaneously, intracavity, or transdermally.

Preparations for parenteral administration include sterile aqueous or non-aqueous solutions, suspensions, and emulsions as known to one of ordinary skill in the art. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's, or fixed oils. Intravenous vehicles include fluid and nutrient replenishers, electrolyte replenishers (such as those based on Ringer's dextrose), and the like. Preservatives and other additives can also be present such as, for example, antimicrobials, anti-oxidants, chelating agents, and inert gases and the like.

Formulations for topical administration, for example, intrarectal administration, can include ointments, lotions, creams, gels, drops, suppositories, sprays, liquids and powders as known to one of ordinary skill in the art. Conventional pharmaceutical carriers, aqueous, powder or oily bases, thickeners and the like can be necessary or desirable.

Compositions for oral administration include powders or granules, suspensions or solutions in water or nonaqueous media, capsules, sachets, or tablets. In some embodiments thickeners, flavorings, diluents, emulsifiers, dispersing aids or binders may be employed.

In some embodiments the compositions can be administered as a pharmaceutically acceptable acid- or base addition salt, formed by reaction with inorganic acids such as hydrochloric acid, hydrobromic acid, perchloric acid, nitric acid, thiocyanic acid, sulfuric acid, and phosphoric acid, and organic acids such as formic acid, acetic acid, propionic acid, glycolic acid, lactic acid, pyruvic acid, oxalic acid, malonic acid, succinic acid, maleic acid, and fumaric acid, or by reaction with an inorganic base such as sodium hydroxide, ammonium hydroxide, potassium hydroxide, and organic bases such as mono-, di-, trialkyl and aryl amines and substituted ethanolamines.

The substances provided herein can be delivered at effective amounts or concentrations. An effective concentration or amount of a substance is one that results in enhanced growth or feed conversion.

Effective dosages and schedules for administering the provided substance can be determined empirically, and making such determinations is within the knowledge of one of ordinary skill in the art. Those of ordinary skill in the art will understand that the dosage of the provided substances that must be administered will vary depending on, for example, the animal that will receive the substance, the route of administration, the particular type of substance used and other drugs being administered, including without limitation antibiotics, probiotics, immune stimulants, anabolic steroids, trace amine-associated receptor 1 (TAAR1) agonists and β adrenoreceptor agonists that stimulate β1 and β2 adrenergic receptors. One of ordinary skill in the art can utilize in vitro assays to optimize the in vivo dosage of a particular substance, including concentration and time course of administration

The compositions provided herein can be used therapeutically in combination with a pharmaceutically acceptable carrier. By “pharmaceutically acceptable” is meant a material that can be administered to an animal, along with the substance, without causing any undesirable biological effects or interacting in a deleterious manner with any of the other components of the pharmaceutical composition in which it is contained. The carrier can be selected to minimize any earlier-than-desired degradation of the active ingredient and to minimize any adverse side effects in the subject, as known to one of ordinary skill in the art.

Administration of PGN, MDP or an MDP analog in nanobeads, microbeads, or beads one or two orders of magnitude greater than microbeads can enhance delivery of the substance by reducing degradation/metabolism in the stomach. Such administration can also enhance uptake in targeted cells in the intestinal tract. These advantages can reduce the dose required for administration.

Pharmaceutical compositions can include carriers, thickeners, diluents, buffers, preservatives, surface-active agents and the like in addition to the molecule of choice. Pharmaceutical compositions can also include one or more active ingredients such as antimicrobial agents, anti-inflammatory agents, anesthetics, and the like. Suitable carriers and their formulations are described in Remington: The Science and Practice of Pharmacy (19th ed.) ed. A. R. Gennaro, Mack Publishing Company, Easton, Pa. 1995). Typically, an appropriate amount of a pharmaceutically acceptable salt is used in the formulation to render the formulation isotonic. Examples of the pharmaceutically acceptable carriers include, but are not limited to, saline, Ringer's solution and dextrose solution. The pH of the solution is preferably from about 5 to about 8, and more preferably from about 7 to about 7.5. Further carriers include sustained release preparations such as semipermeable matrices of solid hydrophobic polymers containing the composition, which matrices are in the form of shaped articles, e.g., films, liposomes or microparticles. It will be apparent to those persons skilled in the art that certain carriers can be more preferable depending upon, for instance, the route of administration and concentration of substance being administered.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention.

### Example 1

### Mifamurtide Improves Feed Conversion in Chickens

The primary objective of this experiment was to evaluate if supplementation of feed with mifamurtide at 1.9 mg/kg feed improves feed conversion in broiler chickens, i.e., if broiler chickens require less feed for the same amount of gain in body weight. A secondary objective was to evaluate whether any such improvement compares favorably or unfavorably to improvement seen with bacitracin, an industry standard AGP. A third objective was to evaluate if fast versus slow acquisition of a healthy microbial flora (microbiome) by the experimental chickens influenced feed conversion. A fourth objective was to determine whether feed supplementation with bacitracin, a commonly used industry-standard antibiotic growth promoter, interacted with a potential influence of microbiome acquisition kinetics on feed conversion.

Two hundred day-of-hatch male Ross×Ross chicks were randomly assigned at 50 each to one of four groups: 1 negative control without microbiome seed chickens; 2 negative control with microbiome seed chickens; 3 bacitracin at 50 mg/kg of feed with microbiome seed chickens; or 4 mifamurtide at 1.9 mg/kg of feed with microbiome seed chickens. The mifamurtide was first mixed with 20 g Lactose (Lactochem Fine Powder, DFE Pharma, Germany), then mixed with corn meal to produce a 2% supplement to prepare the feed, which was fed to the birds ad libitum.

The microbiome seed chickens were healthy 21-day-old birds that had been raised on litter of fresh unused pine shavings, and had not been in contact with any other chickens, and thus had microbiomes characteristic of healthy grown birds. At start of the experiment, groups 2-4 of 50 study chicks were exposed to 10 microbiome seed chickens, which were removed on day 5 and were not counted in study results. The objective of the microbiome seed chickens was to rapidly induce a healthy microbiome in the freshly hatched experimental chickens. In contrast, the development of a normal healthy microbiome required more time in the control group without exposure to microbiome seed chickens.

All chicks were reared with a normal broiler starter in mash form, supplemented with amprolium at 113.5 mg/kg. Each group was raised in 5×10 feet floor pens at a stocking density of 1.0 square foot per bird on fresh pine shavings, in a solid-sided barn, with concrete floors, and under ambient humidity. Feed and water were available ad libitum throughout the trial. Thermostatically controlled gas heaters were the primary heat source for the barn, if needed. One heat lamp per pen provided supplemental heat during brooding. Fans were used to cool birds. The lighting program was as per the primary breeder recommendations. Individual body weights of all birds were recorded on days 8, 21, and 32. Feed was weighed for each pen on day 0 and day 32, when the trial was terminated.

The overall (true) feed conversion for each group was determined by dividing total consumed feed by total weight gains of all chickens of the group. For statistical evaluation of group differences, individual daily and total feed consumption of each bird was mathematically modeled. Calculated feed consumed by birds that died before termination of the experiment was subtracted from total weighed feed. Body weight gain and calculated feed consumption data were analyzed by one-way ANOVA and Tukey Honest True Difference correction for multiple comparisons, and graphs show means±95% confidence intervals. For determination of feed conversion of individual birds, calculated total feed consumption per bird was divided by total weight gain of the bird. This allowed ranking of feed conversion for all birds. Group differences in feed conversion were evaluated by non-parametric Mann Whitney U test, and error bars indicate 25-75 percentiles of calculated feed conversions of individual birds. All significant group differences are indicated by dashed brackets and the corresponding p value.

Individual daily feed consumption per chicken was computed by a mathematical model from individual body weights determined over the course of the 32-day experiment, and from total weighed feed consumed by each group. This model calculates the daily weight and feed consumption of each of the individual birds in the study based on standard male broiler body weight and feed intake data. The model first interpolates body weights between the actual measured body weights of the chickens by a polynomial growth curve that precisely fits (r=0.998) the standard growth of standard male broilers to the bracketing input data of all chickens of the group (e.g., body weight of a chicken starting on day 8 and ending on day 21). This formula is g body weight on dayX=g body weight start day+8.1707×dayX+growth factor×(dayX)². The growth factor is determined for each chicken by starting and end body weight of the time period under consideration. Based on the calculated daily body weight, the daily feed consumption is then calculated by another polynomial equation that precisely fits (r=0.999) the standard feed uptake by male broiler chickens in dependence of body weight. This formula is g daily feed intake=15.4229+0.12×g body weight+1.9288^{-5×9 body weight}^{²}. Since these calculations are based on the standard feed uptake of male broiler chickens, the total feed consumption per group calculated in this way must be calibrated to the actual total feed consumption of the group. This is achieved by a linear multiplication factor derived from the ratio of weighed actual total feed uptake of the group to the calculated uptake. This factor then multiplies each calculated daily feed uptake of each chicken in the group to arrive at a final feed uptake per group that precisely equals the actual total feed uptake.

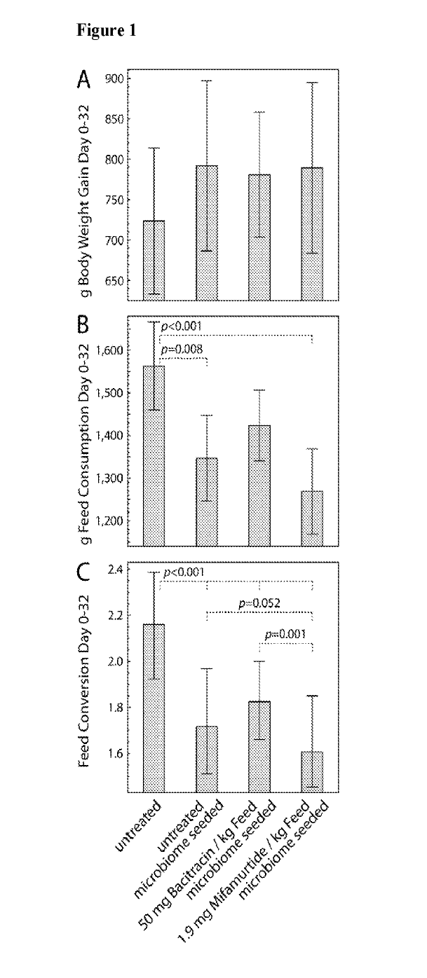

Morbidity and mortality rates did not differ significantly between groups. Growth rates were below standard because of exposure of the chickens to low temperatures during unseasonably cold weather on days 2-6. All significant group differences are indicated by dashed brackets and the corresponding p value. As shown in FIG. 1C, treatment with 1.9 mg mifamurtide/kg feed resulted in the best feed conversion of all groups, at 1.605 g feed/g body weight gain for the grow-out period from days 0 through day 32. This was significantly better than the feed conversion observed for any of the 3 remaining groups. Next were untreated chickens that were exposed to microbiome seed chickens, with a feed conversion of 1.719, requiring 7.1% more feed for the same amount of weight gain than mifamurtide-treated chickens. Use of the industry-standard AGP bacitracin at 50 mg/kg feed resulted in feed conversion of 1.823, thus requiring 13.6% more feed than mifamurtide supplementation for the same amount of weight gain. The worst performing group were untreated chickens that were not exposed to microbiome seed chickens, with a feed conversion of 2.160, requiring 34.6% more feed for the same amount of weight gain than mifamurtide-treated chickens. Therefore, broilers fed the muramyl dipeptide analog mifamurtide had better feed conversion than did negative controls and than did broilers fed bacitracin.

Interestingly, rapid acquisition of a healthy chicken microbiome by exposure to microbiome seed chickens significantly improved feed conversion. Microbiome-seeded untreated chickens had 20.4% improved feed conversion over non-microbiome seeded untreated chickens (1.719 vs. 2.160 feed conversion). Of further interest is that antibiotic feed supplementation appeared to interfere with rapid microbiome acquisition, as evidenced by the only 15.6% improvement in feed conversion of 50 mg/kg bacitracin treated, microbiome-seeded chickens. However, at p=0.09, this difference failed to reach significance.

We conclude from this experiment the following: 1) mifamurtide, supplemented at 1.9 mg/kg feed, significantly improves feed conversion, indicating a growth promoting effect; 2) that this growth promoting effect is significantly stronger than that of bacitracin, an industry-standard growth promoting antibiotic; and, 3) that rapid acquisition of a healthy chicken microbiome independently improves feed conversion. We point out that unlike antibiotics, mifamurtide, like all MDP analogs, does not have a direct antibacterial effect. Therefore, mifamurtide and other MDP derivatives do not interfere with microbiome acquisition of chickens or other animals.

### Example 2

### Effect of Bacitracin, Mifamurtide and Romurtide on Feed Conversion in Chickens

After demonstration in broiler chickens of the growth promoting effect of mifamurtide at 1.9 mg/kg feed, and its superior growth promoting effect over bacitracin, a second experiment without microbiome seed chickens was conducted. Therefore, in this experiment the independent growth promoting effect of feed supplements could be observed without the potentially confounding effect of very rapid acquisition of a healthy microbiome.

The objective of the experiment was to compare the effect of 1) a low dose of 0.1 mg mifamurtide/kg feed; and 2) an intermediate dose of 0.57 mg romurtide/kg feed, a different MDP analog, to 50 mg bacitracin/kg feed and non-supplemented feed (untreated control chickens). Both the effect on feed conversion and on growth rates, i. e. the dual criteria for growth promotion, were examined.

Two-hundred day-of-hatch male Cobb×Cobb chickens were randomly assigned at 50 each to one of four groups: no feed supplementation; bacitracin at 50 mg/kg of feed; mifamurtide at 0.1 mg/kg of feed; or romurtide at 0.57 mg/kg of feed. Microbiome seed chickens were not used, and individual body weights of all birds were recorded on days 15 and 32. All other experimental parameters followed Example 1.

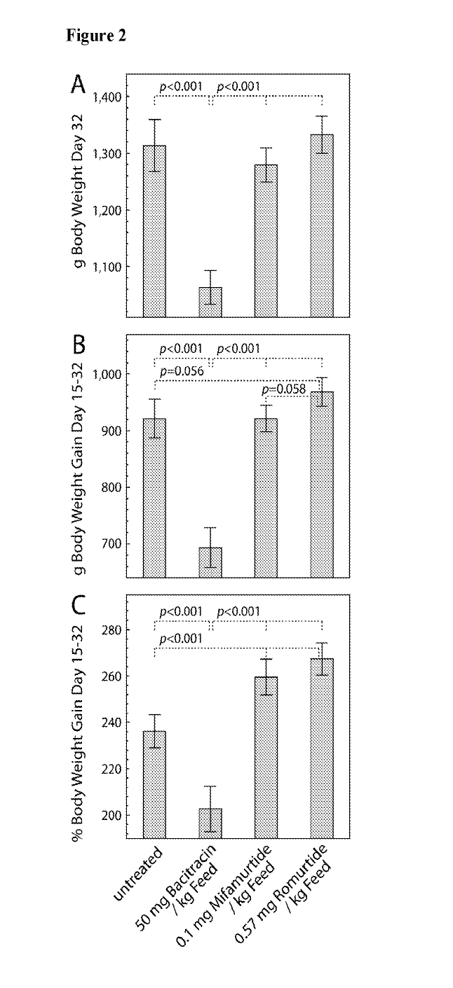

Husbandry conditions were optimal in this experiment, and morbidity and mortality rates were marginal and did not differ between treatment groups. The bacitracin treatment resulted in significantly lower body weights on days 15 and 32, and body weight gains and feed intake for the preceding periods, as well as higher feed conversion rates than for the three other treatments, which were similar in these parameters. However, on day 15 the growth of the 0.1 mg mifamurtide/kg feed or 0.57 mg romurtide/kg feed treatments accelerated over the untreated control. This is evident for romurtide in FIG. 2B for gram body weight gains from day 15 to 32. In addition, the increased growth rate was highly significantly as shown in FIG. 2C for percent body weight gains from day 15 to 32 for both mifamurtide and romurtide treatments.

Therefore, under optimal husbandry conditions and slow acquisition of a healthy microbiome (due to previously unused clean litter and absence of microbiome seed chickens), mifamurtide or romurtide did not decrease feed conversion relative to the untreated control chickens. However, beginning day 15, they strongly improved growth rates over untreated control chickens. The 259.5 and 267.4% growth rates for mifamurtide or romurtide treated chickens from day 15 to 32 represent 9.9 and 13.2% increased growth over the 236.2% rate of untreated control chickens, respectively. It is important to point out that bacitracin, an industry-standard antibiotic growth promoter, in this experiment with optimal husbandry and an absence of a pathogenic microflora had a profoundly negative effect on growth and feed conversion.

We conclude from the experiment in example 2 that 1) treatment with mifamurtide at 0.1 mg/kg feed highly significantly increases the growth rate over the untreated control and the industry-standard antibiotic growth promoter bacitracin at 50 mg/kg feed; 2) romurtide, another MDP analog, at 0.57 mg/kg feed is equal or better to mifamurtide in its growth rate increasing effect; and 3) bacitracin performs in all criteria highly significantly worse than both mifamurtide and romurtide, and untreated controls.

It is noted that MDP and its analogs are ligands of nucleotide-binding oligomerization domain-containing protein 2 (NOD2), which belongs to a family of closely related and presumably redundant intracellular pattern recognition receptors of the innate immune system. NOD2 is present in mammals but absent in birds. Despite the absence of the well-characterized NOD2 receptor for MDP, birds nevertheless responded to MDP analog stimulation with enhanced growth and improved feed conversion.

### Example 3

### Effect of Mifamurtide on Feed Conversion in Pigs

The objective of the experiment for Example 3 was to evaluate if MDP analogs promote growth in mammals as they do in birds. Pigs were selected as an animal model for the mammalian study. This experiment was designed to contrast the effect of a low dose of 0.1 mg mifamurtide/kg feed on growth and feed conversion to untreated control pigs and to pigs treated with 50 mg carbadox/kg feed, an industry-standard AGP used in pigs.

Pigs were weaned at 3-4 weeks of age and allotted based on weight and gender to one of 15 nursery pens with 6 pigs per pen (90 total pigs). Sex of the pigs was balanced within pens in a weight block. Dietary treatments were randomly assigned within weight blocks to pens of pigs. Three dietary treatments were administered in the phase 1 and 2 diets. Phase 1 diets were fed from day 0-14 post-weaning. On day 14 post-weaning, pigs were switched to phase 2 diets, which were fed until day 28. Treatment 1 was the untreated negative control diet without any growth-promoting supplement. Treatment 2 contained carbadox, an industry-standard pig AGP, at 50 mg/kg feed in phase 1 and 25 mg/kg feed in phase 2. Treatment 3 was mifamurtide at 0.1 g/kg feed. Diets were formulated to meet or exceed all the nutrient requirements except energy based on 2012 NRC standards. Feed supplements for treatment 2 and 3 were added as 1% supplements. Mifamurtide was first mixed with 20 g Lactose (Lactochem Fine Powder, DFE Pharma, Germany), then mixed with corn starch to produce a 0.1% premix that was subsequently mixed with non-supplemented feed to a 1% supplement for treatment 3. All diets were fed in meal form. Pigs were weighed on days 0, 7, 14, 21, and 26 post-weaning. Feed intake was monitored for each pen and weigh period. Terminal weight measurements of the study were obtained on day 26.

The overall (true) feed conversion for each group was determined by dividing total consumed feed by total weight gains of all pigs of each treatment. For statistical evaluation of feed consumption and conversion, individual daily and total feed consumption of each pig was mathematically modeled. Body weight gain and calculated feed consumption data were analyzed by one-way ANOVA and Tukey Honest True Difference correction for multiple comparisons. For determination of feed conversion of individual pigs, calculated total feed consumption of each pig was divided by total measured weight gain of the pig. This allowed ranking of feed conversion for all pigs. Group differences in feed conversion were evaluated by non-parametric Mann Whitney U test.

Individual daily feed consumption per pig was computed by a mathematical model from individual body weights determined over the course of the 26-day experiment, and from total weighed feed consumed by each pen. This model calculates the daily weight and feed consumption of each of the individual pigs in the study based on body weight and feed intake data. The model first linearly interpolates body weights between the actual measured body weights of the pigs. Based on the calculated daily body weight, the daily feed consumption is then calculated as 4% of body weight. Since these calculations are based on the standard feed uptake of pigs, the total feed consumption per pen calculated in this way must be calibrated to the actual total feed consumption of the pen. This is achieved by a linear multiplication factor derived from the ratio of weighed actual total feed uptake of the pen to the calculated uptake. This factor then multiplies each calculated daily feed uptake of each pig in the pen to arrive at a final feed uptake per pen that precisely equals the actual total feed uptake.

As shown in FIG. 3C, treatment with 0.1 mg mifamurtide/kg feed resulted in feed conversion of 1.476. This was better than the feed conversion observed for untreated feed, and highly significantly better for feed supplemented with carbadox (50 mg/kg feed until day 14, 25 mg/kg feed after day 14). These treatments at feed conversions of 1.574 and 1.692, respectively, required 6.6% and 14.6% more feed for the same amount of weight gain than treatment with 0.1 mg/kg feed mifamurtide.

We conclude from the experiment in Example 3 that mifamurtide at 0.1 mg/kg feed has in pigs a growth promoting effect compared to pigs without supplemented feed, and highly significantly better than feed supplemented with the industry-standard antibiotic growth promoter carbadox.

### Example 4

### Effect of PGN, MDP and MDP Analogs on Growth and Feed Conversion in Bovines

Administration of PGN, MDP or an MDP analog promotes growth in bovines, including cattle and bison. The compounds are given at daily doses ranging from 0.02 μg/kg to 15 mg/kg body weight. The compounds are preferably mixed into milk exchanger for calves and into compound feed for adult animals. Initial dosing may commence promptly upon birth, or thereafter, and may be continued throughout the life of the animal, or for so long as additional growth or improved feed conversion is desired. The results show that the animals grew faster and had improved feed conversion.

### Example 5

### Effect of PGN, MDP and MDP Analogues on Growth and Feed Conversion in Fish

Administration of PGN, MDP or an MDP analog promotes growth in fish, including salmon and trout. The compounds are given at daily doses ranging from 0.26 μg/kg to 15 mg/kg body weight. The compounds are mixed into pelleted fish feed. Administration may commence as soon as fish hatch or thereafter, and may be continued throughout the life of the animal, or for so long as additional growth or improved feed conversion is desired. The results show that the fish grew faster and had improved feed conversion.

### Example 6

### Effect of PGN, MDP and MDP Analogues on Growth and Feed Conversion in Shrimp

Administration of PGN, MDP or an MDP analog promotes growth in shrimp. The compounds are given at daily doses ranging from 0.46 ng/kg to 75 mg/kg. In a preferred embodiment, they are mixed into the feed or added directly to the habitat water of the shrimp. Administration may commence at the nauplii stage, and may be continued throughout the life of the animal, or for so long as additional growth or improved feed conversion is desired. The results show that the shrimp grew faster and had improved feed conversion.

All patents, publications and abstracts cited above are incorporated herein by reference in their entirety. It should be understood that the foregoing relates only to preferred embodiments of the present invention and that numerous modifications or alterations may be made therein without departing from the spirit and the scope of the present invention as defined in the following claims.

### REFERENCES

Cai et al. Convergent Synthesis of Novel Muramyl Dipeptide Analogues: Inhibition of Porphyromonas gingivalis-Induced Pro-inflammatory Effects by High Doses of Muramyl Dipeptide. J. Med. Chem. 59 (2016) 6878-6890.
Gobec et al. Structural requirements of acylated Gly-L-Ala-D-Glu analogs for activation of the innate immune receptor NOD2. European Journal of Medicinal Chemistry 116 (2016) 1-12.
Lee, K. H.; Liu, Y. J.; Biswas, A.; Ogawa, C.; Kobayashi, K. S. A novel aminosaccharide compound blocks immune responses by toll-like receptors and nucleotide-binding domain, leucine-rich repeat proteins. J. Biol. Chem. 286 (2011) 5727-5735.
Matsumoto et al. Stimulation of Nonspecific Resistance to Infection Induced by Muramyl Dipeptide Analogs Substituted in the γ-Carboxyl Group and Evaluation of N^{α}-Muramyl Dipeptide-N^{ε}-Stearoyllysine. Infection and Immunity 39 (1983) 1029-1040.
Ogawa C, Liu Y-J, Kobayashi K S. Muramyl dipeptide and its derivatives: peptide adjuvant in immunological disorders and cancer therapy. Current bioactive compounds 7 (2011)180-197.
Smrdel at al. Physicochemical and preclinical pharmacokinetic and toxicological evaluation of LK-423-a new phtalimido-desmuramyl-dipeptide derivative with immunomodulating activity. Drμg Development and Industrial Pharmacy 35 (2009) 1293-1304.
U.S. Pat. No. 5,514,654 N-acyldipeptides, processes for the preparation thereof and pharmaceutical compositions containing the same.
West et al. Allometric scaling of metabolic rate from molecules and mitochondria to cells and mammals. PNAS 99 (2002) Suppl 1, 2473-2478.

What is claimed is:

1. A method of improving growth or feed conversion in an animal comprising administering to the animal an effective amount of a composition comprising PGN, MDP or an MDP analog in an acceptable carrier, wherein the amount is effective to improve growth or feed conversion in the animal.

2. The method of claim 1, wherein the MDP analog is selected from the group consisting of romurtide, mifamurtide, L18-MDP and murabutide, or combinations thereof.

3. The method of claim 1, wherein the PGN, MDP or the MDP analog is formulated in beads.

4. The method of claim 1, wherein the PGN is Lys-type PGN or DAP-type PGN.

5. The method of claim 1, wherein the PGN is derived from Streptomyces spp.

6. The method of claim 1 wherein the animal is a vertebrate or invertebrate.

7. The method of claim 6, wherein the vertebrate is a bird, a pig, a cow, a steer, or a fish.

8. The method of claim 6, wherein the vertebrate is a fish selected from the group consisting of salmon, bass, cod, tilapia, catfish and trout.

9. The method of claim 6, wherein the invertebrate is a shrimp, prawn, snail, crayfish, lobster, crab, squid, octopus, oyster, clam or mussel.

10. The method of claim 1, wherein the animal lacks a NOD2 gene.

11. The method of claim 1, wherein the administration is oral or rectal.

12. The method of claim 1, wherein the administration is daily.

13. The method of claim 1, wherein the administration is oral and the carrier is feed or drinking water.

14. The method of claim 1, wherein the effective amount of the composition is 0.0005 μg to 2500 mg.

15. The method of claim 1, wherein the daily dose rate is from 0.01 μg/kg to 150 mg/kg body weight.

16. Use of PGN, MDP or an MDP analog in the preparation of a medicament for enhancing growth or feed conversion in an animal.

17. PGN, MDP or an MDP analog for use in enhancing growth or feed conversion in an animal.
